(19) United States
(12) Patent Application Publication
(10) Pub. No.: US 2023/0056079 A1
(43) Pub. Date: Feb. 23, 2023

(54) TEMPERATURE WARNING INDICATOR FOR A HANDHELD LIGHTER

(71) Applicant: Société BIC, Clichy Cedex (FR)

(72) Inventor: Alexander BOURQUE, Dartmouth (FR)

(73) Assignee: Société BIC, Clichy Cedex (FR)

(21) Appl. No.: 17/759,481

(22) PCT Filed: Dec. 15, 2020
(86) PCT No.: PCT/EP2020/086242

§ 371 Date: Jul. 26, 2022

(30) Foreign Application Priority Data
Jan. 31, 2020 (EP) 20315012.3

(51) Int. Cl. F23Q 2/50; F23Q 2/16; B41M 5/30; C09D 7/63; C09D 5/26; C09D 7/65

(52) U.S. Cl. CPC F23Q 2/50; F23Q 2/161; B41M 5/30; C09D 7/63; C09D 5/26; C09D 7/65

(57) ABSTRACT

The present disclosure relates to a temperature warning indicator for a handheld lighter which warns the user that parts of the lighter may be too hot to touch without burning the user.

### TECHNICAL FIELD

The present disclosure relates to a temperature warning indicator for a handheld lighter which warns the user that parts of the lighter may be too hot to touch without burning the user.

### BACKGROUND OF THE DISCLOSURE

Handheld lighters are widely used for igniting combustible materials such as cigarettes, candles, and many other materials. Although other types are available, the most popular handheld lighter uses a gas flame as a heat source and a metallic wind shield to steady the open gas flame. The gas flame heats the metallic shield and, depending on the length of operation, may cause the metallic shield to reach temperatures which may burn the user when directly touched.

It is the object of the present disclosure provide a simple and cost-effective means to warn the user that the metallic shield of a handheld lighter may be too hot to the touch.

### SUMMARY OF THE DISCLOSURE

In a first aspect, the present disclosure relates to a handheld lighter for igniting a combustible material. The handheld lighter may comprise an ignition mechanism for generating a heat source. It may comprise an actuating means for activating the ignition mechanism. It may comprise a metallic shield positioned adjacent to the ignition mechanism and at a distance to the ignition mechanism such that the metallic shield is heated by the heat source when the handheld lighter is operated. It may comprise a housing. The housing may comprise the ignition mechanism, the actuating means and the metallic shield.

The metallic shield of the handheld lighter may comprise a thermochromic coating. The thermochromic coating may comprise an electron-donative organic compound (component (a)), an electron-accepting compound (component (b)), and a reaction medium which may allow or enable an electron transfer reaction between the components (a) and (b) above the melting or softening point of the reaction medium (component (c)). The electron transfer reaction may be reversible. The thermochromic coating may be configured to reversibly change color in response to an increase of the temperature of the metallic shield to a first temperature of about 60° C. or above. The thermochromic coating may be configured to reversibly change color in response to a decrease of the temperature of the metallic shield to a second temperature which is about 0 to about 20° C. below the first temperature.

In some embodiments, the heat source of the handheld lighter may be a gas flame and the metallic shield may be a wind shield. However, it is also contemplated that the heat source may be from a different source such as a heating coil or an electric arc and other flame generation devices such as piezo, push button or pivoting lead, as well as flameless heating product and that the metallic shield serves a different purpose than shielding the gas flame from wind such as preventing or impeding direct of the heat source by the user.

In some embodiments, the thermochromic coating may comprise core-shell microcapsules. The core-shell microparticles may comprise a core component and a shell component. The core component may comprise the electron-donative organic compound (component (a)), the electron-accepting compound (component (b)), and the reaction medium for enabling a reversible electron transfer reaction between the components (a) and (b) above the melting or softening point of the reaction medium (component (c)). The shell component may comprise an organic polymer.

In some embodiments, the thermochromic coating may be configured to change from a colored state to a decolored state in response to an increase of the temperature of the metallic shield to a first temperature of about 60° C. or above.

In some embodiments, the melting or softening point of the component (c) may remain substantially unchanged after cyclic exposure of the metallic shield to 10 cycles of heating the metallic shield until the metallic shield has reached a temperature of above the melting or softening point of the component (c) followed by cooling the metallic shield to a temperature below the melting or softening point of the component (c). The aforementioned property may describe that component (c) is not having a melt memory effect.

In some embodiments, the reaction medium for enabling a reversible electron transfer reaction between the components (a) and (b) may be a waxy material, in particular a wax. The waxy material or wax may have a melting point of between about 60° C. and about 95° C., specifically between about 60° C. and about 85° C., and in particular between about 65° C. and about 80° C.

In some embodiments, the reaction medium for enabling a reversible electron transfer reaction between the components (a) and (b) above the melting or softening point of the reaction medium (component (c)) may be selected from the group including eicosanol, docosanol, tetracosanol, hexacosanol; stearyl stearate, stearyl arachidate, stearyl behenate, arachidyl stearate, arachidyl arachidate, arachidyl behenate, behenyl stearate, behenyl arachidate, behenyl behenate, pentaerythritol tetrastearate, (dioctadecyl)-3,3′-thiodipropionate; glycerol monolaurate, glycerol monostearate, glycerol dilaurate, glycerol distearate, glycerol dibehenate, glycerol tripalmitate, glycerol tristearate, glycerol tribehenate; cyclododecanone, 4-methoxybenzophenone, 11-heneicosanone, 10-nonadecanone, n-octadecaophenone, ditridecyl ketone, di-n-heptyldecyl ketone; palmitic acid, stearic acid, arachidic acid, behenic acid; n-octacosane, triacontane, tetratriacontane, tetracontane, pentacontane, microcrystalline wax, 2,6-diisopropylnapthalene; n-octadecyl ether, triethylene glycol-bis-3-(3-tert-butyl-4-hydroxy-5-methylphenyl) propionate.

According to an embodiment, the reaction medium for enabling a reversible electron transfer reaction between the components (a) and (b) above the melting or softening point of the reaction medium (component (c)) is not a mixture of compound (c), in particular, not a mixture of the above mentioned reaction medium c).

In some embodiments, the electron-donative organic compound may be selected from 3-(4-diethylamino-2-ethoxyphenyl)-3-(1-ethyl-2-methylindol-3-yl)-4-azaphthalide (Blue 63, CAS number 69898-40-4), 2′-(dibenzylamino)-6′-(diethylamino)fluorane (CAS number 34372-72-0), N,N-dimethyl-4-[2-[2-(octyloxy)phenyl]-6-phenyl-4-pyridinyl]benzenamine (yellow CK37, CAS number 144190-25-0), 7-(4-diethylamino-2-hexyloxyphenyl)-7-(1-ethyl methyl-1H-indol-3-yl)-7H-furo[3,4-b]pyridin-5-one (Blue 203, CAS number 98660-18-5), 2-(2,4-dimethylphenylamino)-3-methyl-6-diethylaminofluoran (Black 15, CAS number: 36431-22-8), and 3,3-bis-(1-butyl-2-methyl-indol-3-yl)-3H-isobenzofuran-1-one (Red 40, CAS number 50292-91-6).

In some embodiments, the electron-accepting compound, also referred to as “developer”, may be selected from 4,4′-cyclohexylidene bisphenol (Bisphenol Z, CAS number 843-55-0), 2,2-bis(4-hydroxy-3-methylphenyl)propane (Bisphenol C, CAS number 79-97-0), 4-hexyl-1,3-dihydroxybenzene (4-hexylresorcinol, CAS number 136-77-6), 4,4′-(hexafluoroisopropylidene)diphenol (Bisphenol AF, CAS number 1478-61-1), 4,4′-(1-phenylethylidene)bisphenol (CAS number 1571-75-1), 2,2′-dihydroxybiphenyl (CAS number 1806-29-7), 4,4′-(1,4-phenylenediisopropylidene)bisphenol (CAS number 2167-51-3), 1,1-bis(4-hydroxy-3-methylphenyl)cyclohexane (CAS number 2362-14-3), 9,9-bis(4-hydroxyphenyl)fluorene (CAS number 3236-71-3), 4,4′-(1,3-phenylenediisopropylidene)bisphenol (CAS number 13595-25-0), 1,1,1-tris(4-hydroxyphenyl)ethane (CAS number 27955-94-8), 4,4′-(2-ethylhexylidene)diphenol (CAS number 74462-02-5), α,α,α′-tris(4-hydroxyphenyl)-1-ethyl-4-isopropylbenzene (CAS number 110726-28-8), 3,5,4′-trihydroxy-trans-stilbene (resveratrol, CAS number 501-36-0).

In some embodiments, the thermochromic coating may further comprise a non-thermosensitive colorant.

In some embodiments, the thermochromic coating may be configured to depict one or more symbols in response to an increase of the temperature of the metallic shield to the first temperature of about 60° C. or above.

In some embodiments, the thermochromic coating may be configured to depict one or more symbols or a color in response to an increase of the temperature of the metallic shield to the first temperature of about 60° C. or above and the one or more symbols or color may be formed by a non-thermosensitive colorant. The thermochromic coating may be configured to at least partially disguise the one or more symbols or color formed by the non-thermosensitive colorant at a temperature of the metallic shield below about the first temperature of about 60° C. and the thermochromic coating may be configured to change from a colored state to a decolored state in response to an increase of the temperature of the metallic shield to the first temperature of about 60° C. or above. In some embodiments, it may be advantageous that the thermochromic coating comprises at least two layers, wherein an inner layer comprises the non-thermosensitive colorant and an outer layer comprises the components (a), (b) and (c).

In some embodiments, the thermochromic coating may be printed onto the metallic shield. In some embodiments, the thermochromic coating may be a label which is affixed onto the metallic shield with an adhesive.

In a second aspect, the present disclosure is directed to a process of preparing a handheld lighter for igniting a combustible material as described in the first aspect of the present disclosure. The process may comprise the set of applying a thermochromic coating as described in the first aspect of the present disclosure onto a metallic shield.

The thermochromic coating may be further defined as for the first aspect of the present disclosure.

In a third aspect, the present disclosure is directed to the use of a thermochromic coating as a temperature warning indicator for a handheld lighter for igniting a combustible material. The handheld lighter may comprise an ignition mechanism for generating a heat source. It may comprise an actuating means for activating the ignition mechanism. It may comprise a metallic shield positioned adjacent to the ignition mechanism and at a distance to the ignition mechanism such that the metallic shield is heated by the heat source when the handheld lighter is operated. It may comprise a housing. The housing may comprise the ignition mechanism, the actuating means and the metallic shield.

The temperature warning indicator may comprise a thermochromic coating. The thermochromic coating may comprise (a) an electron-donative organic compound (component (a)), an electron-accepting compound (component (b)), and a reaction medium which may allow or cause an electron transfer reaction between the components (a) and (b) above the melting or softening point of the reaction medium (component (c)). The electron transfer reaction may be reversible. The thermochromic coating may be configured to reversibly change color in response to an increase of the temperature of the metallic shield to a first temperature of about 60° C. or above. The thermochromic coating may be configured to reversibly change color in response to a decrease of the temperature of the metallic shield to a second temperature which is about 0 to about 20° C. below the first temperature.

The thermochromic coating may be further defined as for the first aspect of the present disclosure.

### BRIEF DESCRIPTION OF THE DRAWINGS

FIG. 1 shows an example of a handheld lighter according to the present disclosure.

FIG. 2 is a graph for explaining a hysteresis characteristic of the thermochromic coloring color-composition of the present disclosure in a color density-temperature curve.

### DETAILED DESCRIPTION OF THE DISCLOSURE

Hereinafter, a detailed description will be given of the present disclosure. The terms or words used in the description and the claims of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

In a first aspect, the present disclosure relates to a handheld lighter for igniting a combustible material. The type of handheld lighter is not particularly limited and may include, amongst others, a lighter that utilizes a gas flame, an electrically heated coil, or an electric arc as a heat source. The handheld lighter may comprise an ignition mechanism for generating the heat source. In case of a gas flame, the ignition mechanism may comprise a means for mechanically or electrically generating a spark and a valve connected to a gas reservoir which supplies combustible gas to the ignition mechanism. The actuating means for activating the ignition mechanism may be lever which opens the valve upon actuation by the user. The handheld lighter may comprise a metallic shield positioned adjacent to the ignition mechanism and at a distance to the ignition mechanism such that the metallic shield is heated by the heat source when the handheld lighter is operated. The shape and purpose of the metallic shield is not particularly limited and can be provided for a number of purposes such as protecting the heat source from outside interference, shielding a gas flame from wind, housing or mounting components of the lighter, or hiding internal components of the lighter from view for aesthetic reasons. The handheld lighter may comprise a housing. The housing may comprise the ignition mechanism, the actuating means and the metallic shield. The housing is not particularly limited and may further comprise additional lighter components such as a reservoir for fueling the heat source of the lighter, in particular a gas tank and/or a battery. Such components may be replaceable or rechargeable.

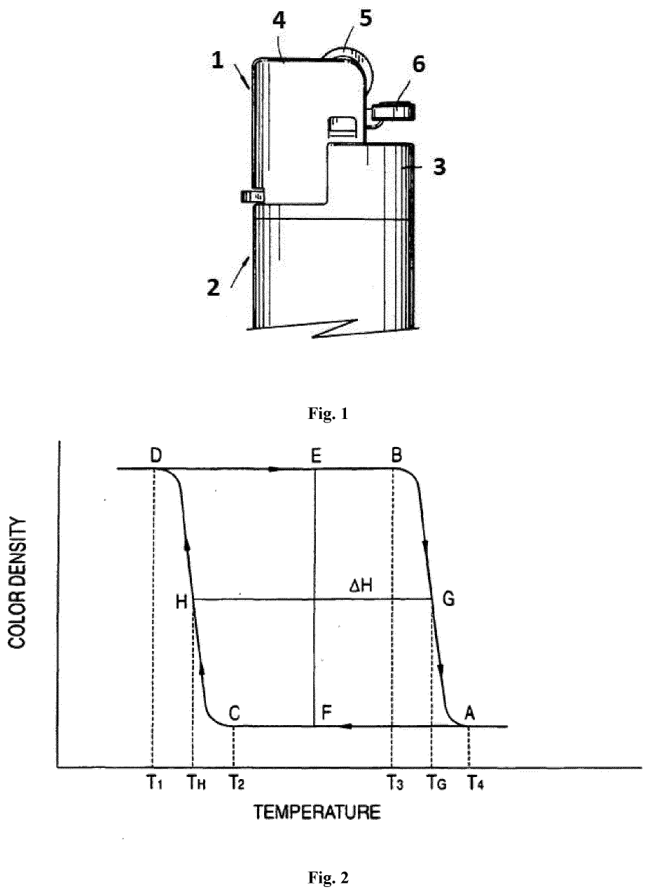

An example of a handheld lighter according to the present disclosure is described below with reference to FIG. 1.

In one embodiment, the handheld lighter according to the present disclosure may generate a gas flame. Accordingly, the lighter may comprise an upper portion 1 and a lower portion 2. Lower portion 2 may contain the tank for the fuel used, in particular liquid butane gas under pressure, or some other conventional lighter fuel. The upper portion 1 may comprise an upper seat member 3 mounting the ignition mechanism including a nozzle and valve mechanism, an actuation means for operating the valve mechanism, as well as wind shield 4 mounting and enclosing the ignition mechanism. In the embodiment shown in FIG. 1, the ignition mechanism is of the well-known mechanical type comprising a hand-actuated ignition wheel or drum 5 and flint arranged for cooperation therewith. The ignition wheel 5 may comprise two knurled side sections of slightly larger diameter for actuation by the user, and a main section of slightly smaller diameter and having a suitably roughened surface to strike ignition sparks from a flint stone arranged to cooperate with the ignition wheel, on actuation thereof. The ignition wheel 5 may slightly project from the upper end of windshield 4, for actuation by the user, whereas the flint stone may be arranged below the horizontally mounted ignition wheel 5 so that the generated ignition sparks will be directed towards a burner unit of the ignition mechanism within windshield 4. In the embodiment according to FIG. 1, the lighter may comprise an actuating means which comprises an actuating lever 6 pivotably mounted below the ignition wheel 5 and arranged such in a manner that if the user actuates ignition wheel 5 with the thumb of the hand holding the lighter, the thumb will press lever 6 causing its counter-piece to pivot from its rest position into an actuated position in which the valve which is cooperatively arranged with said counter-piece is opened such that gas may be supplied to the burner unit of the ignition mechanism.

The metallic shield of the handheld lighter may comprise a thermochromic coating. The term thermochromic coating may refer to the fact that the color appearance of a coating on the metallic shield changes in response to a temperature change of the metallic shield. The type of coating is not particularly limited and intended to in particular also include films, labels and strips of materials which are provided on the surface of the metallic shield. The thermochromic coating may comprise an electron-donative organic compound (component (a)), an electron-accepting compound (component (b)), and a reaction medium which may allow or enable an electron transfer reaction between the components (a) and (b) above the melting or softening point of the reaction medium (component (c)). The electron transfer reaction may be reversible. The thermochromic coating may be configured to reversibly change color in response to an increase of the temperature of the metallic shield to a first temperature of about 60° C. or above. The thermochromic coating may be configured to reversibly change color in response to a decrease of the temperature of the metallic shield to a second temperature which is about 0 to about 20° C. below the first temperature. It should be understood that the aforementioned color-change refers to the color impression (to the human eye) derived from the color-forming electron transfer reaction between component (a) and (b) and in particular includes a change from color to colorless and vice-versa, and perceivable changes in color intensity.

As stated, the thermochromic coating may be configured to reversibly change color in response to an increase of the temperature of the metallic shield to a first temperature of about 60° C. or above. In general, whereas temperatures of above 48.8° C. (120° F.) are classified by authorities as “too hot to safely touch” since—at this temperature—skin proteins start to denature, it was found that at temperatures of above about 60° C. the risk of scalding the skin at short contact times has reached a level which is sufficiently significant to warrant a specific warning to the user. Accordingly, the temperature threshold of about 60° C. provided by the aforementioned first temperature is selected to reduce the chances the user accidentally burning herself/himself with the heated lighter at even short contact times. Connected to this, the thermochromic coating may be configured to reversibly change color in response to a decrease of the temperature of the metallic shield to a second temperature which is about 0 to about 20° C. below the temperature threshold of about 60° C. This ensures that the user is indicated when it is again safe to briefly touch the lighter and/or even pocket the lighter.

In some embodiments, it may be advantageous that thermochromic coating is configured to reversibly change color in response to an increase of the temperature of the metallic shield to a first temperature of about 65° C. or above, or about 70° C. or above, or about 75° C. or above.

In some embodiments, it may be advantageous that thermochromic coating is configured to reversibly change color in response to an increase of the temperature of the metallic shield to a first temperature which is in the range of about 60 to about 90° C., more specifically of about 60° C. to about 80° C., and in particular of about 60° C. to about 75° C.; or above.

The electron-donative organic compound (component (a)) may be a compound which develops a color impression by reacting with an electron-accepting compound. The electron-donative color developing organic compound is not particularly limited as long as it is suitable to form a thermochromic coating which may be configured to reversibly change color in response to an increase of the temperature of the metallic shield to a first temperature of about 60° C. or above and to reversibly change color in response to a decrease of the temperature of the metallic shield to a second temperature which is about 0 to about 20° C. below the first temperature.

In some embodiments, the electron-donative organic compound may be selected from 3-(4-diethylamino-2-ethoxyphenyl)-3-(1-ethyl-2-methylindol-3-yl)-4-azaphthalide (Blue 63, CAS number 69898-40-4), 2′-(dibenzylamino)-6′-(diethylamino)fluorane (CAS number 34372-72-0), N,N-dimethyl-4-[2-[2-(octyloxy)phenyl]-6-phenyl-4-pyridinyl]benzenamine (yellow CK37, CAS number 144190-25-0), 7-(4-diethylamino-2-hexyloxyphenyl)-7-(1-ethyl-2-methyl-1H-indol-3-yl)-7H-furo[3,4-b]pyridin-5-one (Blue 203, CAS number 98660-18-5), 2-(2,4-dimethylphenylamino)-3-methyl-6-diethylaminofluoran (Black 15, CAS number: 36431-22-8), and 3,3-bis-(1-butyl-2-methyl-indol-3-yl)-3H-isobenzofuran-1-one (Red 40, CAS number 50292-91-6).

It should be understood that a single electron-donative organic compound may be used or that a plurality of electron-donative organic compounds may be used. This may allow to fine-tune the perceived color impression.

The electron-accepting compound (component (b)) may be a compound which reacts with the electron-donative organic compound under formation of a colorant or of a color impression. The electron-accepting compound may be a compound which has an active proton, a pseudo acidic compound or a compound having an electron hole. The electron-accepting compound is not particularly limited and may be in particular selected from a compound having a phenolic hydroxyl group (such as phenol, o-cresol, m-octylphenol, n-dodecylphenol, n-stearylphenol, bisphenols, and resorcinols), carboxylic acids and the metal salts thereof (such as zinc salicylate, zinc 3,5-di(alpha-methylbenzyl) salicylate), acidic phosphate esters and metal salts thereof, urea thiourea-based compound and derivatives thereof and 1,2,3-triazole and derivatives thereof. Of course, it must be suitably selected to be able to form a thermochromic coating which may be configured to reversibly change color in response to an increase of the temperature of the metallic shield to a first temperature of about 60° C. or above and to reversibly change color in response to a decrease of the temperature of the metallic shield to a second temperature which is about 0 to about 20° C. below the first temperature.

In some embodiments, the electron-accepting compound may be selected from 4,4′-cyclohexylidene bisphenol (Bisphenol Z, CAS number 843-55-0), 2,2-bis(4-hydroxy-3-methylphenyl)propane (Bisphenol C, CAS number 79-97-0), 4-hexyl-1,3-dihydroxybenzene (4-hexylresorcinol, CAS number 136-77-6), 4,4′-(hexafluoroisopropylidene)diphenol (Bisphenol AF, CAS number 1478-61-1), 4,4′-(1-phenylethylidene)bisphenol (CAS number 1571-75-1), 2,2′-dihydroxybiphenyl (CAS number 1806-29-7), 4,4′-(1,4-phenylenediisopropylidene)bisphenol (CAS number 2167-51-3), 1,1-bis(4-hydroxy-3-methylphenyl)cyclohexane (CAS number 2362-14-3), 9,9-bis(4-hydroxyphenyl)fluorene (CAS number 3236-71-3), 4,4′-(1,3-phenylenediisopropylidene)bisphenol (CAS number 13595-25-0), 1,1,1-tris(4-hydroxyphenyl)ethane (CAS number 27955-94-8), 4,4′-(2-ethylhexylidene)diphenol (CAS number 74462-02-5), α,α,α′-tris(4-hydroxyphenyl)-1-ethyl isopropylbenzene (CAS number 110726-28-8), 3,5,4′-trihydroxy-trans-stilbene (resveratrol, CAS number 501-36-0).

It should be understood that a single electron-accepting compound may be used or that a plurality of electron-accepting compounds may be used. This may allow to fine-tune the perceived color impression.

In some embodiments, it may be advantageous that the thermochromic coating is configured to change from a colored state to a decolored state in response to an increase of the temperature of the metallic shield to the first temperature of about 60° C. or above. This property may be particularly beneficial to hide a temperature warning indicator which is revealed upon elevation of the temperature above a safety threshold. More specifically, it may be advantageous that the thermochromic coating is configured to reversibly discolor in response to an increase of the temperature of the metallic shield to a first temperature of about 60° C. or above and to reversibly recolor in response to a decrease of the temperature of the metallic shield to a second temperature which is about 0 to about 20° C., specifically about 2 to 16° C., more specifically about 2 to about 11° C., and in particular about 4 and about 9° C., below the first temperature.

Without wishing to be bound by theory, the discoloring effect upon an increase in temperature described in the aforementioned embodiment may be explained as follows: Components (a) and (b) may have formed a colored intermolecular complex in an electron-transfer reaction. The reaction medium (component (c)) may disrupt the electron transfer reaction between the components (a) and (b) above the melting or softening point of the reaction medium, hence causing the discoloration reaction. At about or above the softening or melting temperature of the reaction medium, component (c) may be sufficiently mobile to disrupt the electron transfer reaction between the components (a) and (b). Afterward, the component (c) may act as a solvent surrounding and isolating the components (a) and (b) from each other (solvating), thereby substantially preventing the color-forming electron transfer reaction between the components (a) and (b) at temperatures which are above the melting point or softening point of the reaction medium. Below the melting point or softening point of the reaction medium (c), the mixture (or the coating) is colored, due to the color-forming electron transfer reaction between component (a) and (b).

The melting point or softening point of the reaction medium may be determined by established means, such as differential thermal analysis (DTA) or differential scanning calorimetry (DSC).

In some embodiments, the reaction medium for enabling a reversible electron transfer reaction between the components (a) and (b) may be a waxy material. It should be understood that the term “waxy material” may refer to a wax or a material having wax-like properties, such as a malleable solid state at ambient temperatures and a defined melting point (in contrast to a melting point range as in case of many polymeric materials). It may be advantageous that the waxy material is a wax.

In some embodiments, the reaction medium for enabling a reversible electron transfer reaction between the components (a) and (b) above the melting or softening point of the reaction medium (component (c)) may be selected from the group including:
alcohols, in particular an aliphatic linear alcohol having at least about 20 carbon atoms, more specifically an aliphatic linear alcohol having from about 20 to about 30 carbon atoms, even more specifically an alcohol selected form eicosanol, docosanol, tetracosanol, hexacosanol;
carboxylic acid esters, in particular aliphatic carboxylic esters, or mono-, di-, tri-, or tetra-esters of carboxylic acids, or esters of an carboxylic acid having at least about 12 carbon atoms; and in particular stearyl stearate, stearyl arachidate, stearyl behenate, arachidyl stearate, arachidyl arachidate, arachidyl behenate, behenyl stearate, behenyl arachidate, behenyl behenate, pentaerythritol tetrastearate, (dioctadecyl)-3,3′-thiodipropionate;
ketones, in particular cyclododecanone, 4-methoxybenzophenone, 11-heneicosanone, 10-nonadecanone, n-octadecaophenone, ditridecyl ketone, di-n-heptyldecyl ketone;
carboxylic acids, such as aliphatic carboxylic acids having at least about 16 carbon atoms, particularly such as palmitic acid, stearic acid, arachidic acid, behenic acid;
hydrocarbons, in particular a hydrocarbon defined as organic compounds consisting entirely of hydrogen and carbon, more particularly straight-chained hydrocarbons having at least about 26 carbon atoms, more particularly having from about 26 to about 50 to carbon atoms, and even more particularly a hydrocarbon selected from n-octacosane, triacontane, tetratriacontane, tetracontane, pentacontane, microcrystalline wax;
ethers, in particular-octadecyl ether, triethylene glycol-bis-3-(3-tert-butyl-4-hydroxy-5-methylphenyl) propionate;
and mixtures thereof.

In some embodiments, it may be advantageous that the reaction medium for enabling a reversible electron transfer reaction between the components (a) and (b) above the melting or softening point of the reaction medium (component (c)) is selected from eicosanol, docosanol, tetracosanol, hexacosanol; stearyl stearate, stearyl arachidate, stearyl behenate, arachidyl stearate, arachidyl arachidate, arachidyl behenate, behenyl stearate, behenyl arachidate, behenyl behenate, pentaerythritol tetrastearate, (dioctadecyl)-3,3′-thiodipropionate; cyclododecanone, 4-methoxybenzophenone, 11-heneicosanone, 10-nonadecanone, n-octadecaophenone, ditridecyl ketone, di-n-heptyldecyl ketone; palmitic acid, stearic acid, arachidic acid, behenic acid; n-octacosane, triacontane, tetratriacontane, tetracontane, pentacontane, microcrystalline wax, n-octadecyl ether, triethylene glycol-bis-3-(3-tert-butyl-4-hydroxy-5-methylphenyl) propionate.

According to an embodiment, it may be advantageous that the reaction medium for enabling a reversible electron transfer reaction between the components (a) and (b) above the melting or softening point of the reaction medium (component (c)) is not a mixture of compound (c), in particular, not a mixture of the above mentioned reaction medium (component (c)).

In some embodiments, the reaction medium (component (c)) may be characterized by having a melting point or softening point of between about 60° C. and about 95° C. It may be advantageous that the reaction medium has a melting point or softening point of about 60° C. and about 85° C., in particular of about 65° C. and about 80° C. The melting point or softening point of the core component may be determined by established means, such as differential thermal analysis (DTA) or differential scanning calorimetry (DSC).

In some embodiments, it may be advantageous that the melting or softening point of the component (c) remains substantially unchanged after cyclic exposure of the metallic shield to 10 cycles of heating the metallic shield until the metallic shield has reached a temperature of above the melting or softening point of the component (c) followed by cooling the metallic shield to a temperature below the melting or softening point of the component (c). The aforementioned property may describe that component (c) is not having a melt memory effect. Not having a melt memory effect for the component (c) may be beneficial for increasing the reliability in warning the user that the metallic shield is too hot to touch. However, such precision may not be needed for all applications. In this context, the term “substantially unchanged” is not particularly limited and in particular intended to refer to melting or softening points of the component (c) which differ by less than about 3° C., more specifically less than about 2° C., and in particular less than about 1° C., after the aforementioned cyclic exposure.

The components (a), (b), and (c) may be suitably selected such that the thermochromic coating may reversibly change color in response to an increase of the temperature of the metallic shield to a first temperature of about 60° C. or above and to reversibly change color in response to a decrease of the temperature of the metallic shield to a second temperature which is about 0 to about 20° C. below the first temperature.

Without wishing to be bound by theory, the above properties may also be referred to as a thermochromic coating having a narrow hysteresis. The property of hysteresis will be elaborated in the following with reference to FIG. 2. FIG. 2 is a graph explaining the hysteresis characteristic of the thermochromic coating in a color density-temperature curve. In FIG. 2, shows the color development of a typical thermochromic coating. The color density of the thermochromic coating is plotted on the ordinate and the temperature on the abscissa. In this example, the thermochromic coating discolors with an increase in temperature. The change in the color density due to a temperature change will be explained following the progresses the lines of arrows. In FIG. 2, D is a point showing the density at a temperature T1 at which a completely colored state is given. With an increase in temperature, the completely colored state can be maintained until point B at temperature T3 is reached. Typically, this point approximately coincides with the onset of melting or softening of component (c). The coating then rapidly discolors until temperature T4 (wherein T4 corresponds to the complete melting or softening temperature of component (c)), at which a discolored state is reached. When again cooling the coating, the discolored state is maintained until point C, at temperature T2, is reached. This behavior of thermochromic pigments is well-established in the art. The length of the line segment EF is a measure showing contrast of discoloration, and the length of the line segment HG is a temperature width showing the hysteresis (AH). The line segment HG (i.e. the hysteresis ΔH) is based on temperatures T_{H} and T_{G} which are half-way between T1 and T2 and T3 and T4, respectively. It is a measure of how rapidly the color change takes place and how accurately the color change correlates to a specific temperature. As indicated, above the hysteresis should be narrow, i.e. AH should have a low value, for instance less than about 20° C., specifically less than about 15° C., more specifically less than about 10° C. and in particular less than about 5° C.

Having a thermochromic coating with a narrow hysteresis is a further safety feature for a lighter since—as explained above—it not only reliably informs the user when the lighted is heating up too high to be safe to the touch but also when the lighter has cooled enough to be again touched or pocketed.

According to the present disclosure, for ease of reference and in view of embodiments in which an otherwise hidden temperature warning indicator is revealed at elevated temperatures, the increase of the temperature to “first temperature of about 60° C. or above” may refer to the temperature correlating to (substantially) complete discoloration (temperature T4). At this temperature, any temperature warning indicator may be best visible. Likewise, the decrease of the temperature to “a second temperature which is about 0 to about 20° C. below the first temperature” may refer to temperature correlating to (substantially) complete (re-)coloration of the thermochromic coating (temperature T1). At this temperature, any temperature warning indicator may be best hidden by the thermochromic coating. Accordingly, in some embodiments, the second temperature may be less than about 16° C., specifically less than about 11° C., more specifically less than about 5° C. and in particular less than about 2° C., below the first temperature.

In some embodiments, it may be advantageous to add a nucleation agent to the component (c). This may be helpful to further narrow the hysteresis.

In some embodiments, the thermochromic coating may comprise core-shell microcapsules. The core-shell microparticles may comprise a core component and a shell component. The core component may comprise the electron-donative organic compound (component (a)), the electron-accepting compound (component (b)), and the reaction medium for enabling a reversible electron transfer reaction between the components (a) and (b) above the melting or softening point of the reaction medium (component (c)). The shell component may comprise an organic polymer. Such an arrangement may be beneficial to facilitate stability and uniformity of the color change over time by introducing a further barrier which protects the components (a), (b), and (c) from external influences.

In some embodiments, the shell component may comprise a polyurea, a polymer derived from melamine, a polymer derived from guanamines, a polyamide, a polyester, a polyurethane, a polycondensation polymer, and mixtures thereof. It may be advantageous that the shell component comprises a melamine-formaldehyde resin.

The size of the core-shell microcapsules is not particularly limited as long as the size of microcapsules in the nanometer or micrometer-range. In some embodiments, the microcapsules may have a size of about 0.1 μm to about 100 μm, in particular about 0.1 μm to about 50 μm, specifically about 0.2 μm to about 20 μm, and in particular about 0.5 μm to about 10 μm. The microcapsules may generally have a spherical or substantially spherical shape and, thus, their size can be determined by conventional means such as microscopy or electron microscopy. In these cases, the measured 2-dimensional representation of the microcapsule diameter may be seen as representative for the afore-mentioned size of the microcapsules.

In some embodiments, it may be advantageous that the content of the electron-donative organic compound is from about 0.01% to about 15% by weight, and in particular from about 0.1% to about 10% by weight, based on the thermochromic coating as a whole.

In some embodiments, it may be advantageous that the electron-donative organic compound is contained in microcapsules in an amount of from about 0.1% by weight to about 30% by weight, and in particular from about 1% by weight to about 20% by weight, of microcapsules.

In some embodiments, it may be advantageous that the content of the electron-accepting compound is from about 0.01% to about 15% by weight, and in particular from about 0.1% to about 10% by weight, of the thermochromic coating as a whole.

In some embodiments, it may be advantageous that the electron-accepting compound is contained in the microcapsules in an amount of from about 0.1% by weight to about 30% by weight, and in particular from about 1% by weight to about 20% by weight, of microcapsules.

In some embodiments, it may be advantageous that the content of the reaction medium (component (c)) is from about 2% to about 50% by weight, and in particular from about 3% to about 45% by weight, of the thermochromic coating as a whole.

In some embodiments, it may be advantageous that the content of the reaction medium (component (c)) is an amount of from about 20% by weight to about 95% by weight, and in particular from about 30% by weight to about 90% by weight, of microcapsules.

In some embodiments, it may be advantageous that thermochromic coating may further comprise a non-thermosensitive colorant. Adding a non-thermosensitive colorant may be beneficial to add contrast or to modulate the color impression. It may also allow to incorporate a permanent temperature warning indicator which is modulated or hidden by the thermochromic coating.

In some embodiments, it may be advantageous that thermochromic coating may be configured to depict one or more symbols in response to an increase of the temperature of the metallic shield to a first temperature of about 60° C. or above or above about 65° C. or above about 70° C. or above about 75° C. In some embodiments, the thermochromic coating may be configured to depict one or more symbols or a color in response to an increase of the temperature of the metallic shield to a first temperature of about 60° C. or above, or above about 60° C. or above about 65° C. or above about 70° C. or above about 75° C., and the one or more symbols or color may be formed by a non-thermosensitive colorant. The thermochromic coating may be configured to at least partially disguise the one or more symbols or color formed by the non-thermosensitive colorant at a temperature of the metallic shield below about 60° C., or about 65° C. or about 70° C. or about 75° C., and the thermochromic coating may be configured to change from a colored state to a decolored state in response to an increase of the temperature of the metallic shield to a first temperature of about 60° C. or above, or above about 60° C. or above about 65° C. or above about 70° C. or above about 75° C. In some embodiments, it may be advantageous that the thermochromic coating comprises at least two layers, wherein an inner layer comprises the non-thermosensitive colorant and an outer layer comprises the components (a), (b) and (c).

In some embodiments, the thermochromic coating may be printed onto the metallic shield. In some embodiments, the thermochromic coating may be a label which is affixed onto the metallic shield with an adhesive.

In a second aspect, the present disclosure is directed to a process of preparing a handheld lighter for igniting a combustible material as described in the first aspect of the present disclosure. The process may comprise the set of applying a thermochromic coating as described in the first aspect of the present disclosure onto a metallic shield.

It should be understood that the embodiments referred to above with respect to the first aspect of the disclosure equally apply to and are combinable with the second aspect of the disclosure.

In a third aspect, the present disclosure is directed to the use of a thermochromic coating as a temperature warning indicator for a handheld lighter for igniting a combustible material. The handheld lighter may comprise an ignition mechanism for generating a heat source. It may comprise an actuating means for activating the ignition mechanism. It may comprise a metallic shield positioned adjacent to the ignition mechanism and at a distance to the ignition mechanism such that the metallic shield is heated by the heat source when the handheld lighter is operated. It may comprise a housing. The housing may comprise the ignition mechanism, the actuating means and the metallic shield.

The temperature warning indicator may comprise a thermochromic coating. The thermochromic coating may comprise an electron-donative organic compound (component (a)), an electron-accepting compound (component (b)), and a reaction medium which may allow or cause an electron transfer reaction between the components (a) and (b) above the melting or softening point of the reaction medium (component (c)). The electron transfer reaction may be reversible. The thermochromic coating may be configured to reversibly change color in response to an increase of the temperature of the metallic shield to a first temperature of about 60° C. or above. The thermochromic coating may be configured to reversibly change color in response to a decrease of the temperature of the metallic shield to a second temperature which is about 0 to about 20° C. below the first temperature.

It should be understood that the embodiments referred to above with respect to the first aspect of the disclosure equally apply to and are combinable with the third aspect of the disclosure.

In the following the present disclosure will be further elaborated by way of Examples.

### EXAMPLES

The preparation of the thermochromic pigments and microcapsules is well-known in the art. These pigments and microcapsules can be processed to coatings and labels by conventional ink processing technology.

In a first simple example, a red leuco dye (3,3-bis-(1-butyl-2-methyl-indol-3-yl)-3H-isobenzofuran-1-one (Red 40, CAS number 50292-91-6)) is formulated with 4,4′-cyclohexylidene bisphenol (Bisphenol Z, CAS number 843-55-0) and with I-eicosanol (melting point: 64° C.) to provide a red thermochromic coating at room temperature which is discolored upon heating the windshield of a gas-flame lighter at 64° C. and recolors upon cooling the metallic windshield to below 59° C.

In a more elaborate second example, the metallic windshield of a handheld gas-flame lighter is first coated with a permanent non-thermochromic coating which contains a water- and light-resistant red pigment (for example Levanyl Rot BB-LF from Lanxess). The coating is applied onto the metallic windshield to form of a red temperature warning indicator, more specifically the wording “BURN RISK”. This first coating is overcoated with a thermochromic coating composition comprising conventionally prepared core-shell microcapsules comprising 2-(2,4-dimethylphenylamino)-3-methyl-6-diethylaminofluoran (Black 15, CAS number: 36431-22-8, available from Chemos GmbH & Co. KG) as component (a), 4,4′-cyclohexylidene bisphenol (Bisphenol Z, CAS number 843-55-0, available from Sigma-Aldrich) as component (b), and 1-eicosanol (a wax with a melting point of 64° C., available from Sigma-Aldrich) as component (c) in a formaldehyde-melamine shell. The thermochromic coating composition is black at room temperature and disguises the red temperature warning indicator, more specifically the wording “BURN RISK” at room temperature. The black thermochromic coating turns transparent at about the melting temperature of the component (c), i.e. at about 64° C., revealing the wording red wording “BURN RISK”. Once the metallic windshield cools below about 60° C., the thermochromic coating rapidly turns black again and hides the temperature warning indicator. Since 1-eicosanol is a wax not having a melt memory effect, the temperature at which the temperature warning indicator is revealed remains substantially unchanged after cyclic exposure of the metallic shield to 10 cycles of heating the metallic shield to above 64° C., followed by cooling the metallic shield to temperatures below 60° C.

In a third example, the coating layers of the second example are applied to a label having an adhesive layer. The label is then attached to the metallic windshield of a handheld gas-flame lighter.

Although the preferred embodiments of the present disclosure have been disclosed for illustrative purposes, those skilled in the art will appreciate that various modifications and alterations are possible, without departing from the spirit of the present disclosure. It is also to be understood that such modifications and alterations are incorporated in the scope of the present disclosure and the accompanying claims.

1-15. (canceled)

16. A handheld lighter for igniting a combustible material comprising:
an ignition mechanism for generating a heat source;
an actuating means for activating the ignition mechanism;
a metallic shield positioned adjacent to the ignition mechanism and at a distance to the ignition mechanism such that the metallic shield is heated by the heat source when the handheld lighter is operated; and
a housing comprising the ignition mechanism, the actuating means and the metallic shield;
wherein the metallic shield comprises a thermochromic coating comprising:
(a) an electron-donative organic compound (component (a)),
(b) an electron-accepting compound (component (b)), and
(c) a reaction medium enabling a reversible electron transfer reaction between the components (a) and (b) above the melting or softening point of the reaction medium (component (c)); and
wherein the thermochromic coating is configured to reversibly change color in response to an increase of the temperature of the metallic shield to a first temperature of about 60° C. or above and to reversibly change color in response to a decrease of the temperature of the metallic shield to a second temperature which is about 0 to about 20° C. below the first temperature.

17. The handheld lighter of claim 16, wherein the heat source is a gas flame and wherein the metallic shield is a wind shield.

18. The handheld lighter of claim 17, wherein the thermochromic coating comprises core-shell microcapsules, wherein the core-shell microcapsules comprise a core component and a shell component, wherein the core component comprises the electron-donative organic compound (component (a)), the electron-accepting compound (component (b)), and the reaction medium for enabling a reversible electron transfer reaction between the components (a) and (b) above the melting or softening point of the reaction medium (component (c)) and wherein the shell component comprises an organic polymer.

19. The handheld lighter of claim 16, wherein the thermochromic coating is configured to change from a colored state to a discolored state in response to an increase of the temperature of the metallic shield to the first temperature of about 60° C. or above.

20. The handheld lighter of claim 16, wherein the melting or softening point of the component (c) remains substantially unchanged after cyclic exposure of the metallic shield to 10 cycles of heating the metallic shield until the metallic shield has reached a temperature of above the melting or softening point of the component (c) followed by cooling the metallic shield to a temperature below the melting or softening point of the component (c).

21. The handheld lighter of claim 16, wherein the reaction medium for enabling a reversible electron transfer reaction between the components (a) and (b) is a waxy material having a melting point of between about 60° C. and about 95° C.

22. The handheld lighter of claim 16, wherein the reaction medium for enabling a reversible electron transfer reaction between the components (a) and (b) is a waxy material, having a melting point of between about 60° C. and about 85° C.

23. The handheld lighter of claim 16, wherein the reaction medium for enabling a reversible electron transfer reaction between the components (a) and (b) is a waxy material, having a melting point of between about 65° C. and about 80° C.

24. The handheld lighter of claim 16, wherein the reaction medium for enabling a reversible electron transfer reaction between the components (a) and (b) is a wax.

25. The handheld lighter of claim 16, wherein the reaction medium for enabling a reversible electron transfer reaction between the components (a) and (b) above the melting or softening point of the reaction medium (c) is selected from the group of eicosanol, docosanol, tetracosanol, hexacosanol; stearyl stearate, stearyl arachidate, stearyl behenate, arachidyl stearate, arachidyl arachidate, arachidyl behenate, behenyl stearate, behenyl arachidate, behenyl behenate, pentaerythritol tetrastearate, (dioctadecyl)-3,3′-thiodipropionate; glycerol monolaurate, glycerol monostearate, glycerol dilaurate, glycerol distearate, glycerol dibehenate, glycerol tripalmitate, glycerol tristearate, glycerol tribehenate; cyclododecanone, 4-methoxybenzophenone, 11-heneicosanone, 10-nonadecanone, n-octadecaophenone, ditridecyl ketone, di-n-heptyldecyl ketone; palmitic acid, stearic acid, arachidic acid, behenic acid; n-octacosane, triacontane, tetratriacontane, tetracontane, pentacontane, microcrystalline wax, 2,6-diisopropylnapthalene; n-octadecyl ether, triethylene glycol-bis-3-(3-tert-butyl-4-hydroxy-5-methylphenyl) propionate.

26. The handheld lighter of claim 16, wherein the electron-donative organic compound is selected from 3-(4-diethylamino-2-ethoxyphenyl)-3-(1-ethyl-2-methylindol-3-yl)-4-azaphthalide (Blue 63, CAS number 69898-40-4), 2′-(dibenzylamino)-6′-(diethylamino)fluorane (CAS number 34372-72-0), N,N-dimethyl-4-[2-[2-(octyloxy)phenyl]-6-phenyl-4-pyridinyl]benzenamine (yellow CK37, CAS number 144190-25-0), 7-(4-diethylamino-2-hexyloxyphenyl)-7-(1-ethyl-2-methyl-1H-indol-3-yl)-7H-furo[3,4-b]pyridin-5-one (Blue 203, CAS number 98660-18-5), 2-(2,4-dimethylphenylamino)-3-methyl-6-diethylaminofluoran (Black 15, CAS number: 36431-22-8), and 3,3-bis-(1-butyl-2-methyl-indol-3-yl)-3H-isobenzofuran-1-one (Red 40, CAS number 50292-91-6) and/or wherein the electron-accepting compound is selected from 4,4′-cyclohexylidene bisphenol (Bisphenol Z, CAS number 843-55-0), 2,2-bis(4-hydroxy-3-methylphenyl)propane (Bisphenol C, CAS number 79-97-0), 4-hexyl-1,3-dihydroxybenzene (4-hexylresorcinol, CAS number 136-77-6), 4,4′-(hexafluoroisopropylidene)diphenol (Bisphenol AF, CAS number 1478-61-1), 4,4′-(1-phenylethylidene)bisphenol (CAS number 1571-75-1), 2,2′-dihydroxybiphenyl (CAS number 1806-29-7), 4,4′-(1,4-phenylenediisopropylidene)bisphenol (CAS number 2167-51-3), 1,1-bis(4-hydroxy-3-methylphenyl)cyclohexane (CAS number 2362-14-3), 9,9-bis(4-hydroxyphenyl)fluorene (CAS number 3236-71-3), 4,4′-(1,3-phenylenediisopropylidene)bisphenol (CAS number 13595-25-0), 1,1,1-tris(4-hydroxyphenyl)ethane (CAS number 27955-94-8), 4,4′-(2-ethylhexylidene)diphenol (CAS number 74462-02-5), α,α,α′-tris(4-hydroxyphenyl)-1-ethyl-4-isopropylbenzene (CAS number 110726-28-8), 3,5,4′-trihydroxy-trans-stilbene (resveratrol, CAS number 501-36-0).

27. The handheld lighter of claim 16, wherein the thermochromic coating further comprises a non-thermosensitive colorant.

28. The handheld lighter of claim 16, wherein the thermochromic coating is configured to depict one or more symbols in response to an increase of the temperature of the metallic shield to the first temperature of about 60° C. or above.

29. The handheld lighter of claim 16, wherein the thermochromic coating is configured to depict one or more symbols or a color in response to an increase of the temperature of the metallic shield to the first temperature of about 60° C. or above, wherein the one or more symbols or color are formed by a non-thermosensitive colorant;
wherein the thermochromic coating is configured to at least partially disguise the one or more symbols or color formed by the non-thermosensitive colorant at the first temperature of the metallic shield below about 60° C.; and
wherein the thermochromic coating is configured to change from a colored state to a decolored state in response to an increase of the temperature of the metallic shield to the first temperature of about 60° C. or above.

30. The handheld lighter of claim 29, wherein the thermochromic coating comprises at least two layers, wherein an inner layer comprises the non-thermosensitive colorant and an outer layer comprises the components (a), (b) and (c).

31. The handheld lighter of claim 16, wherein the thermochromic coating is printed onto the metallic shield or wherein the thermochromic coating is a label which is affixed onto the metallic shield with an adhesive.

32. A process of preparing a handheld lighter for igniting a combustible material according to claim 16, comprising applying a thermochromic coating onto a metallic shield.

33. A method of using a thermochromic coating as a temperature warning indicator for a handheld lighter for igniting a combustible material;
wherein the handheld lighter for igniting a combustible material comprises:
an ignition mechanism for generating a heat source;
an actuating means for activating the ignition mechanism;
a metallic shield positioned adjacent to the ignition mechanism and at a distance to the ignition mechanism such that the metallic shield is heated by the heat source when the handheld lighter is operated; and
a housing comprising the ignition mechanism, the actuating means and the metallic shield; and
wherein the thermochromic coating comprises:
(a) an electron-donative organic compound (component (a)),
(b) an electron-accepting compound (component (b)), and
(c) a reaction medium for enabling a reversible electron transfer reaction between the components (a) and (b) above the melting or softening point of the reaction medium (component (c)); and
wherein the thermochromic coating is configured to reversibly change color in response to an increase of the temperature of the metallic shield to a first temperature of about 60° C. or above and to reversibly change color in response to a decrease of the temperature of the metallic shield to a second temperature which is about 0 to about 20° C. below the first temperature.
